(19) United States
(12) Patent Application Publication
(10) Pub. No.: US 2009/0265175 A1
(43) Pub. Date: Oct. 22, 2009

(54) Method and system for providing a translation service for a voice channel

(75) Inventor: Taiyuan Fang, San Diego, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM COROPRATION, Irvine, CA (US)

(21) Appl. No.: 12/148,163

(22) Filed: Apr. 16, 2008

(51) Int. Cl. G10L 11/00

(52) U.S. Cl. 704/277

(57) ABSTRACT

There is provided a method for providing a translation service for a voice channel. The method comprises receiving a translation request from a first person at a first endpoint of the voice channel, selecting a language translator based on the translation request received from the first person, and installing the language translator in the voice channel for providing the translation service between the first person at the first endpoint of the voice channel and a second person at a second endpoint of the voice channel. The translation request may include digits dialed as part of a phone number associated with the second endpoint, and wherein the translation request includes information indicative of a first language and a second language for translation.

### BACKGROUND OF THE INVENTION

1. Field of the Invention

The present invention is generally in the field of communication systems. More particularly, the present invention relates to translation services in communication systems.

2. Background Art

The global economy has advanced to the point where people perform day-to-day business with essentially anyone located anywhere in the world. This advancement has brought many advantages with it, including improved business and personal communications, and has facilitated the rapid pace of globalization. Unfortunately, the practice of multi-lingualism has not advanced nearly as quickly as the art of modern telephony, and many individuals can still speak, for example, only one language, or at most two.

Because there are thousands of spoken languages, the advantages of global telephony are often blunted by the difficulties of cross-language understanding, resulting in poorer business and personal communications and a decline in the pace of global integration. Today, awkward and frustrating conventional steps must be taken before any dialog can be achieved between speakers of dissimilar languages. For instance, the first speaker must learn the language of the second, or both speakers must learn a third common tongue. Even then, when at least one speaker does not speak the second language fluently, quite often, the substance, tone and feel of the conversion are also lost or misunderstood

Thus, there is a need in the art for a solution to the problem of communication between speakers of different languages that can overcome the drawbacks associated with the conventional solutions.

### SUMMARY OF THE INVENTION

A method and system for providing a translation service for a voice channel, substantially as shown in and/or described in connection with at least one of the figures, and as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for providing a translation service for a voice channel, according to one embodiment of the present invention; and

FIG. 2 is a flowchart presenting a method for providing a translation service for a voice channel, according to one embodiment of the present invention.

### DETAILED DESCRIPTION OF THE INVENTION

The present invention is directed to a method and system for providing a translation service for a voice channel. Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

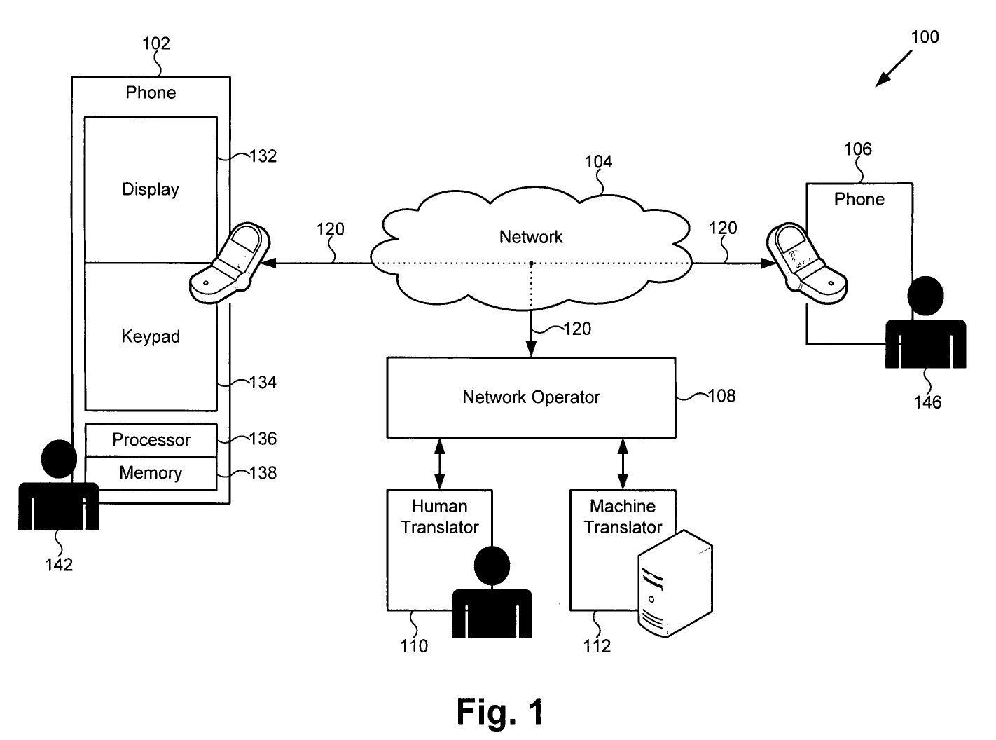

FIG. 1 shows exemplary system 100 for providing a translation service for a voice channel, according to one embodiment of the present invention. System 100 comprises phone 102, network 104, and phone 106. Phone 102 is utilized by person 142, while phone 106 is utilized by person 146. System 100 also comprises network operator 108, human translator 110, and machine translator 112. Channel 120 connects endpoints comprising phone 102, phone 106, and network operator 108 via network 104.

Phone 102, which may be a cell phone, comprises display 132, keypad 134, processor 136, and memory 138. Phone 102 additionally comprises a power source, an antenna, a microphone, and a speaker, which are not shown. Processor 136 can execute software in memory 138 to control display 132, keypad 134, and other aspects of phone 102. While in this embodiment phone 102 is a cellular telephone, in other embodiments phone 102 may be another endpoint, such as, for example, a landline phone or a VOIP (“Voice Over IP”) software phone. Phone 106 comprises substantially the same components (not shown) as phone 102 in this embodiment, although in other embodiments phone 106 may be an endpoint dissimilar to phone 102. Persons 142 and 146 can utilize phones 102 and 106, respectively, to have a voice conversation over channel 120.

Network 104, in this embodiment, comprises one or more cellular network transceivers (not shown) configured to communicate with endpoints such as phones 102 and 106 and network operator 108. In the present embodiment, network 104 is configured to communicate with cell phones, but in another embodiment of the invention network 104 may comprise, for example, POTS (“Plain Old Telephone Service”) infrastructure to communicate with landline phone endpoints, or Internet infrastructure to communicate with VOIP software phone endpoints. Network 104 can support voice channels and control channels between endpoints. In the present embodiment, channel 120 comprises both a voice channel and a control channel. Further, in this embodiment, the voice channel of channel 120 is utilized to carry speech in a digital format, and requires relatively high bandwidth, while the control channel of channel 120 is utilized to carry digital commands requiring relatively low bandwidth. Other embodiments may utilize analog voice communication or control channels, or may provide a unitary voice communication and control channel.

Network operator 108 is configured to provide translation services for voice channels in network 104. In this embodiment, network operator 108 is an owner-operator of network 104, whose services also comprise providing cell phone account service to persons 142 and 146. In other embodiments of the invention, network operator 108 may instead be a third-party service provider who is not an owner-operator of network 104. Network operator 108 is configured to install a language translator, such as human translator 110 or machine translator 112, into a voice channel of channel 120. Installing a language translator into a voice channel comprises, in this embodiment, making the language translator audible to the endpoints of the voice channel, and making the endpoints of the voice channel audible to the language translator. Thus, for example, human translator 110 may be installed in channel 120 by configuring human translator 110 to talk to and listen to persons 142 and 146 utilizing phones 102 and 106.

Human translator 110 is a multilingual person who can translate speech between two or more languages, and additionally comprises supporting equipment for communicating on a voice channel. Human translator 110 must be, at a minimum, a bilingual person, who utilizes a microphone and a speaker to perform language translations in a call center of network operator 108. In this embodiment, human translator 110 is an employee of network operator 108, but in other embodiments of the invention the multilingual person may be, for example, an independent contractor providing translation services from a home office or a remote location outside of facilities of network operator 108.

Like human translator 110, machine translator 112 can translate speech between two or more languages, and must be, at a minimum, bilingual. Instead of using a multilingual person to translate speech, machine translator 112 operates by executing translation software to translate speech. Thus, in this embodiment, machine translator 112 is a computer running translation software configured to input speech in a first language and output speech in a second language, in a fashion similar to that of human translator 110. In other embodiments of the invention, machine translator 112 may utilize software configured to input preprocessed speech in a first language, such as, for example, speech that has been preprocessed by software executing on processor 136 of phone 102.

In operation, person 142 can utilize phone 102 to initiate a voice conversation with person 146. To initiate the voice conversation, a phone number to be dialed associated with phone 106 can be entered onto keypad 134 by person 142. Alternatively, person 142 can utilize keypad 134 to operate a UI (“User Interface”) menu displayed on display 132 to look up and dial the phone number associated with phone 106. In another embodiment of the invention, phone 102 can dial a number associated with phone 106 by executing voice activation software on processor 136 capable of understanding a name of person 146 spoken by person 142 to phone 102.

In some circumstances, person 142 may request a translation service from network operator 108 prior to beginning a voice conversation with person 146. For example, person 142 may be, for example, a monolingual English speaker, and may know that person 146 is, for example, a monolingual Spanish speaker. As an alternative example, person 142, capable of speaking only English, may know that person 146 lives and works in Spain, making it likely that person 146 prefers speaking Spanish instead of English. In both circumstances, while dialing a number for phone 106 utilizing a method described above, person 102 may additionally utilize phone 102 to request a translation service. Thus, for example, person 142 may dial a number for phone 106 and subsequently or previously dial a translation request suffix or prefix, respectively, on keypad 134. A translation request suffix or prefix may comprise, for example, a string of digits signifying a particular two-language translation scheme, i.e., the suffix 0011 may signify an English-Spanish translation request. Alternatively, person 142 may utilize keypad 134 to operate a UI menu displayed on display 132 to look up and dial the phone number associated with phone 106, and then operate the UI menu to make a translation request. In one embodiment, the translation request may include digits dialed as part of a phone number associated with phone 106, and the translation request may include information indicative of a first language and a second language for translation by human translator 110 or machine translator 112.

A translation request sent by phone 102 is a command transmitted via a control channel of channel 120, in contrast to the voice conversation that is transmitted via a voice channel of channel 120. The translation request sent by phone 102 will be routed by network 104 to network operator 108 via channel 120. Network operator 108, upon receiving the translation request, can then install human translator 110, or machine translator 112, as appropriate, into the voice channel of channel 120. For example, machine translator 112 can be installed if phones 102 and 106 are configured with translation preprocessing software to operate in concert with machine translator 112, but human translator 110 can be installed if phones 102 and 106 are not so configured. In this embodiment, network operator 108 receives a translation request for an English-Spanish translator from phone 102, and installs human translator 110 comprising an English-Spanish bilingual person into the voice channel of channel 120. The bilingual person can thus talk with person 142 via phone 102, and person 146 via phone 106.

In some circumstances, person 142 may send a translation request for a translation service to network operator 108 during a voice conversation with person 146, instead of requesting the translation service prior to initiating the voice conversation. For example, person 142 may be a monolingual English speaker and may not be aware that person 146 is a monolingual Spanish speaker. This might be the case if, for example, persons 142 and 146 are strangers and no geographical clues are operating to suggest a language preference of person 146 to person 142. In this case, after initiating a voice conversation with person 146, person 142 does not need to terminate and reinitiate the voice conversation with a translation request. Instead, person 142 can, for example, enter a code on keypad 134 or utilize keypad 134 to operate a UI menu displayed on display 132 to send a translation request while the voice conversation is active. Thus, unnecessary delay can be avoided, and network operator 108 can install human translator 110 or machine translator 112 into a voice channel of channel 120 to begin English-Spanish translation in the ongoing voice conversation.

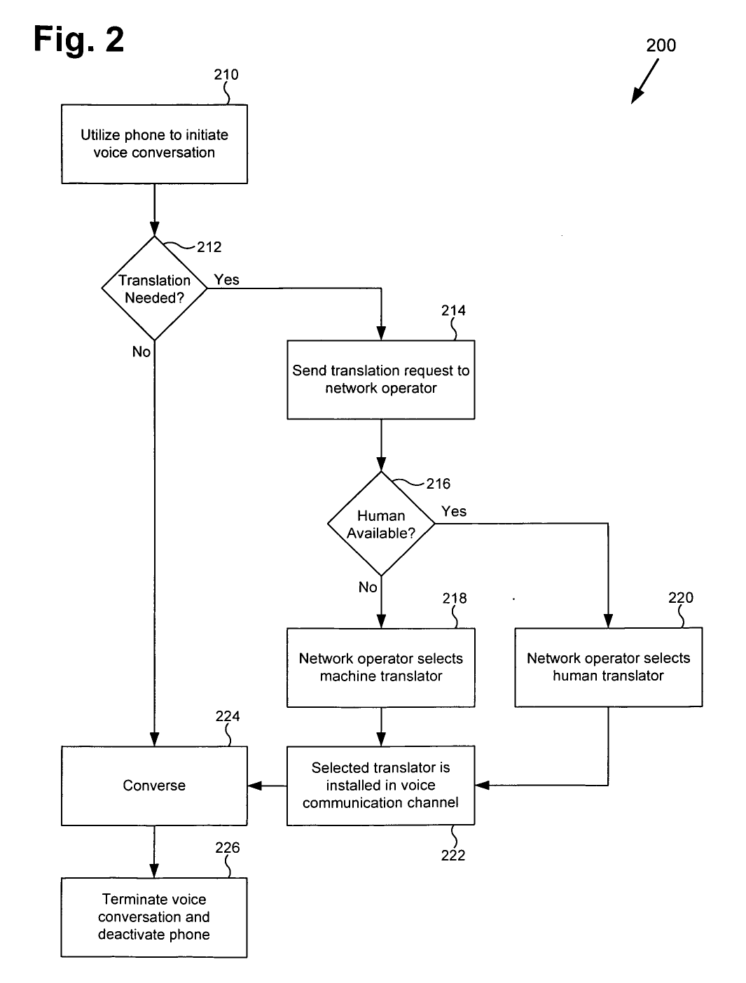

FIG. 2 shows flowchart 200 of an exemplary method for providing a translation service to a voice channel, according to one embodiment of the present invention. Certain details and features have been left out of flowchart 200 that are apparent to a person of ordinary skill in the art. For example, a step may comprise one or more substeps or may involve specialized equipment or materials, as known in the art. While steps 210 through 226 indicated in flowchart 200 are sufficient to describe one embodiment of the present invention, other embodiments of the invention may utilize steps different from those shown in flowchart 200.

In step 210 of flowchart 200, a person, for example person 142 in FIG. 1, utilizes a first phone such as phone 102 to initiate a voice conversation with a second person, such as person 146 of FIG. 1, who utilizes a second phone such as phone 106. The voice conversation may be initiated by, for example, dialing a number on the first phone manually, by operating a UI menu on a display of the first phone, or by dialing a number on the first phone using a voice recognition mode of the first phone. After dialing a number on the first phone, a voice channel between the first phone and the second phone can be established.

In step 212 of flowchart 200, the first person utilizing the first phone to initiate the voice conversation makes a decision about whether translation services are needed. The decision about whether translation services are needed can be made concurrently with step 210, i.e. while initiating a voice conversation utilizing the first phone, or subsequently, after the voice channel has been established. The former circumstance might occur when, for example, the first person is aware that the second person speaks a different language, while the latter circumstance might occur when, for example, the first person has started a voice conversation with a stranger and has discovered that the stranger speaks a different language. If the first person is able to speak the language of the second person, flowchart 200 will proceed to step 224, but otherwise flowchart 200 will proceed to step 214.

In step 214 of flowchart 200, the first person has decided that a translation service is needed in the voice conversation, and the first person thus proceeds to send a translation request for a translation service to a network operator, such as network operator 108 in FIG. 1. In other embodiments, the second person may request a translation service. In one embodiment of the invention, the translation request may be a rich command specifying the languages to be translated, while in another embodiment the translation request may be a bare command merely requesting that an assistant enter the voice conversation. In the latter embodiment, the assistant may be a human translator estimated by the network operator to be sufficient for the translation request; i.e., the network operator may make assumptions as to what kind of translation service will be required based on factors such as the geographic or national locations of the first and second phones. Instead, the assistant may be a simple human operator who can make further inquiries about what translation service is required in the voice conversation. After a rich command has specified what translation service is required, or a bare command has prompted an assistant to determine what translation service is required, flowchart 200 proceeds to step 216.

In step 216 of flowchart 200, the network operator has made a decision about what translation service is required in the voice conversation, and next decides whether to install a human translator or a machine translator into the voice channel. A human translator, like human translator 110 of FIG. 1, comprises a multilingual person who can translate speech between two or more languages, and additionally comprises supporting equipment for communicating on a voice channel. Similarly, the machine translator, like machine translator 112 of FIG. 1, can translate speech between two or more languages, and must also be, at a minimum, bilingual. Instead of using a multilingual person to translate speech, the machine translator executes translation software to translate speech. The machine translator may operate independent of translation hardware or software on the first or second phone, or may operate in concert with such hardware or software, i.e. the first or second phone may preprocess speech for the machine translator.

The network operator may select a human translator, and proceed through step 220, or may choose a machine translator, and proceed through 218. Factors involved in the choice may include, for example, the current availability of human translators versus the current availability of machine translators, the difficulty of the particular translation service required, or service entitlements or service grades of the first or second persons having the voice conversation. After selecting either a human or machine translator, flowchart 200 proceeds to step 222.

In step 222 of flowchart 200, a human or machine translator has been installed in the voice channel and has begun performing a translation service. Thus enabled, the first and second persons having the voice conversation may proceed, as depicted in step 224, to have a voice conversation, unimpeded by language differences. The speech of the first person can be translated into the language of the second person, and vice versa, by the installed translator, until the voice conversation is finished and flowchart 200 proceeds to step 226.

In step 226 of flowchart 200, the voice conversation between the first and second person is terminated. This may be accomplished, for example, by severing the voice channel by turning off or hanging up the first and second phones. After the voice conversation is terminated, the installed translator may be removed from the voice channel and placed in a pool of translators available for servicing other translation requests, in the case of a human translator, or simply turned off, in the case of a machine translator.

In this manner, the invention as shown in exemplary system 100 and flowchart 200 solves the problem of communication between speakers of different languages and overcomes the drawbacks associated with conventional solutions. In particular, the people participating in the conversation, i.e. people 142 and 146, are not required to know each other's languages, or a third common language. Nor do the people participating in the conversation need to make a timely or costly search for a translator. Rather, various embodiments of the present invention can quickly and transparently provide a translation service with minimal effort on the part of the parties to the conversation.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

1. A method for providing a translation service for a voice channel, the method comprising:
receiving a translation request from a first person at a first endpoint of the voice channel;
selecting a language translator based on the translation request received from the first person; and
installing the language translator in the voice channel for providing the translation service between the first person at the first endpoint of the voice channel and a second person at a second endpoint of the voice channel.

2. The method of claim 1, wherein the translation request includes digits dialed as part of a phone number associated with the second endpoint, and wherein the translation request includes information indicative of a first language and a second language for translation.

3. The method of claim 1, further comprising establishing the voice channel after receiving the translation request from the first person at the first endpoint.

4. The method of claim 1, further comprising removing the language translator from the voice channel after the language translator provides the translation service.

5. The method of claim 1, wherein the first endpoint of the voice channel comprises a cell phone.

6. The method of claim 1, wherein the first endpoint of the voice channel comprises a landline phone.

7. The method of claim 1, wherein the first endpoint of the voice channel comprises a VOIP software phone.

8. The method of claim 1, wherein the language translator comprises a machine translator executing translation software.

9. The method of claim 1, wherein the translation request comprises a command in a control channel separate from the voice channel.

10. The method of claim 1, wherein the translation request comprises a command in the voice channel.

11. A system for providing a translation service for a voice channel, the system comprising:
an interface configured to communicate with a first person at a first endpoint of the voice channel;
a memory configured to store parameters relating to a plurality of language translators; and
a processor configured to receive a translation request from the first person at the first endpoint via the interface, the processor further configured to select a language translator from the plurality of language translators based on the translation request received from the first person, the processor further configured to install the language translator in the voice channel via the interface for providing the translation service between the first person at the first endpoint of the voice channel and a second person at a second endpoint of the voice channel.

12. The system of claim 1, wherein the translation request includes digits dialed as part of a phone number associated with the second endpoint, and wherein the translation request includes information indicative of a first language and a second language for translation.

13. The system of claim 1, wherein the processor is further configured to establish the voice channel after receiving the translation request from the first person at the first endpoint.

14. The system of claim 11, wherein the processor is further configured to remove the language translator from the voice channel after the language translator provides the translation service.

15. The system of claim 11, wherein an endpoint of the voice channel comprises a cell phone.

16. The system of claim 11, wherein an endpoint of the voice channel comprises a landline phone.

17. The system of claim 11, wherein an endpoint of the voice channel comprises a VOIP software phone.

18. The system of claim 11, wherein the language translator comprises a machine translator executing translation software.

19. The system of claim 11, wherein the translation request comprises a command in a control channel separate from the voice channel.

20. The system of claim 11, wherein the translation request comprises a command in the voice channel.
